(19) United States
(12) Patent Application Publication
(10) Pub. No.: US 2016/0279619 A1
(43) Pub. Date: Sep. 29, 2016

(54) Graphene-Supported NiPd Alloy Nanoparticles for Effective Catalysis of Tandem Dehydrogenation of Ammonia Borane and Hydrogenation of Nitro/Nitrile Compounds

(71) Applicant: BROWN UNIVERSITY, Providence, RI (US)

(72) Inventors: Shouheng Sun, East Greenwich, RI (US); Sally Fae Ho, Skokie, IL (US); Adriana Mendoza-Garcia, Boston, MA (US)

(21) Appl. No.: 14/667,859

(22) Filed: Mar. 25, 2015

(51) Int. Cl. B01J 23/89; C07B 31/00; C01B 3/04; B01J 35/00; B01J 35/02; C07B 43/04; B01J 21/18

(52) U.S. Cl. CPC B01J 23/892; C07B 43/04; C07B 31/00; B01J 21/18; B01J 35/0013; B01J 35/023; C01B 3/04

(57) ABSTRACT

Monodisperse NiPd alloy nanoparticles (NPs) are synthesized and assembled on graphene (G) or other support to provide clean, efficient catalysis of tandem reactions—dehydrogenation of ammonia borane (AB) and hydrogenation of R—NO₂ and/or R—CN to R—NH₂. The tandem reactions proceed quickly and with high efficiency in aqueous methanol solutions at room temperature, and the supported catalyst is readily recovered for re-use, providing a simple, efficient and ‘green’ route to the preparation of many common pharmaceutical, dye or other chemical products. NiPd alloy NPs of 3.4 nanometer size were prepared by co-reduction of nickel(II) acetate and palladium(II) acetlyacetonate by borane-tert-butylamine in oleylamine and deposited on G via a solution phase self-assembly process. The G-NiPd showed composition-dependent catalysis on the tandem reaction with G-Ni₃₀Pd₇₀ being the most active. A variety of R—NO₂ and/or R—CN derivatives (R alkyl or aryl) were reduced selectively into R—NH₂ via G-Ni₃₀Pd₇₀ catalyzed tandem reaction in short (5-30 minute) reaction times with conversion yields reaching up to 100%, demonstrating a new approach to G-NiPd-catalyzed dehydrogenation of AB and hydrogenation of R—NO₂ and R—CN. The G-NiPd NP catalyst is efficient and is reusable; thus the reaction can be performed in an environment-friendly process with short reaction times and high yields.

### GOVERNMENT SUPPORT

This invention was made with government support under W911NF-11-1-0353 awarded by the U.S. Army Research Office. The government has certain rights in the invention.

### BACKGROUND

Aromatic and aliphatic primary amines (here denoted R-NH₂) constitute an important class of compounds used as intermediates in the synthesis of numerous pharmaceutical, dye, polymer and natural products. See, Downing, R. S., Kunkeler, P. J., van Bekkum, H. Catal. Today 1997, 37, 121-136; Ono, N.; The Nitro Group in Organic Synthesis, Wiley-VCH, New York, 2001; Kim, D.; Guengerich, F. P.; Annu. Rev. Pharmacol. Toxicol. 2005, 45, 27-49; and Wang, K.; Guengerich, F. P. Chem. Res. Toxicol. 2013, 26, 993-1004. R—NH₂ compounds are often synthesized by the reductive amination of aldehydes and alcohols in the presence of a hydrogen source. Alternatively, the amines can be prepared by direct hydrogenation of aromatic or aliphatic nitro (R—NO₂) and nitrile (R—CN) compounds in the presence of noble metal catalysts under high hydrogen pressures and high temperatures. For a recent overview on synthetic aspects of the catalytic reduction of nitroarenes, see: Blaser, H. U.; Siegrist, U.; Steiner, H.; and Studer, M. in: Fine Chemicals through Heterogeneous Catalysis Wiley-VCH, Weinheim, p. 389, 2001; see also Blaser, H-U.; Steiner, H.; Studer, M. ChemCatChem 2009, 1, 210-221. For reviews on transfer hydrogenation, see: Gladiali S.; Mestroni, G.; in Transition Metals for Organic Synthesis, Wiley-VCH: Weinheim, p. 145, 2004; Gladiali S., Alberico, E. Chem. Soc. Rev, 2006, 35, 226-236; and Samec, J. S. M.; Backvall, J.-E.; Andersson, P. G.; Brandt, P. Chem. Soc. Rev. 2006, 35, 237-248.

To create more environmentally benign conditions, alcohols have been used as alternative hydrogen sources, such as ethanol: Chandrappa, S.; Vinaya, K.; Ramakrishnappa, T.; Rangappa, K. S. Synlett 2010, 20, 3019-3022; isopropanol: Mohapatra, S. K.; Sonavane, S. U.; Jayaram, R. V.; Selvam, P. Tetrahedron Lett. 2002, 43, 8527-8529; and glycerol: Wolfson, A.; Dlugy, C.; Shotland, Y.; Tavor, D. Tetrahedron Lett. 2009, 50, 5951-5953; see also Gawande, M. B.; Rathi, A. K.; Branco, P. S.; Nogueira, I. D.; Velhinho, A.; Shrikhande, J. J.; Indulkar, U. U.; Jayaram, R. V.; Ghumman, C. A. A.; Bundaleski, N.; Teodoro, O.M.N.D. Chem. Eur J., 2012, 18, 12628-12632. However, the reported alcohol-initiated hydrogenation reactions are slow and have low reaction selectivity.

Recently, ammonia borane (AB, NH₃.BH₃) has become a popular choice as a hydrogen source for the reduction process due to its high volume/mass hydrogen density, its nontoxicity and its high-solubility in water. Peng, B.; Chen, J. Energy Environ. Sci. 2008, 1, 479-483; Demirci, U. B.; Miele, P. Energy Environ. Sci. 2009, 2, 627-637; Smythe, N. C.; Gordon, J. C. Eur. J. Inorg. Chem. 2010, 509-521; and Umegaki, T.; Yan, J-M.; Zhang, X-B.; Shioyama, H.; Kuriyama, N.; Xu, Q. Int. J. Hydrogen Energy 2009, 34, 2303-2311. AB has been used to reduce C═C, C═N and C═O bonds in aqueous solutions under ambient conditions. Yang, X.; Fox, T.; Berke, H. Chem. Commun. 2011, 47, 2053-2055; Yang, X.; Zhao, L.; Fox, T.; Wang, Z.-X.; Berke, H. Angew. Chem., Int. Ed. 2010, 49, 2058-2062; and Yang, X.; Fox, T.; Berke, H. Tetrahedron, 2011, 67, 7121-7127.

Palladium-based catalysts have previously been shown to facilitate the dehydrogenation of AB—see Kiliç, B.; Sencanh, S.; Metin, Ö. J. Mol. Catal. A: Chem. 2012, 361-362, 104-110; also Akbayrak, S.; Kaya, M.; Volkan, M.; Ozkar, S. AppL Catal. B 2014, 147, 387-393; Erdogan, H.; Metin, O.; Ozkar, S. Phys. Chem. Chem. Phys. 2009, 11, 10519-10525; and Metin, Ö; Sahin, S.; Özkar, S. Int. J. Hydrogen Energy, 2009, 34, 6304-6313. Palladium-based catalysts have also been used to selectively hydrogenate a variety of substrates. See Niu, Y. H.; Yeung, L. K.; Crooks, R. M. J. Am. Chem. Soc. 2001, 123, 6840-6846; Maegawa, T.; Takahashi, T.; Yoshimura, M.; Suzuka, H.; Monguchi, Y.; Sajiki, H. Adv. Synth. Catal. 2009, 351, 2091-2095; Ueno, T.; Suzuki, M.; Goto, T.; Matsumoto, T.; Nagayama, K.; Watanabe, Y. Angew. Chem. Int. Ed. 2004, 43, 2527-2530.

Applicant reasoned that a catalytic tandem reaction in which Pd serves a dual role to catalyze the dehydrogenation of AB and to hydrogenate R—NO₂ or R—CN could potentially be an efficient way to generate primary amines, R—NH₂. Considering the enhanced catalytic performance and selectivity that has been observed for bimetallic NPs demonstrated in hydrogenation reactions (see Sankar, M.; Dimitratos, N.; Miedziak, P. J.; Wells, P. P.; Kielye, C. J.; Hutchings, G. J. Chem. Soc. Rev., 2012, 41, 8099-8139; Liu, X.; Wang, D.; Li, Y. Nano Today 2012, 7, 448-466; and Singh, A. K., Xu, Q. ChemCatChem, 2013, 5, 652-676; and also demonstrated for dehydrogenation of AB—see: Singh, A. K.; Xu, Q. ChemCatChem 2013, 5, 3000-3004; Jiang, H. L.; Umegaki, T.; Akita, T.; Zhang, X. B.; Haruta, M.; Xu, Q. Chem. Eur. J. 2010, 46, 3132-3137; Rachiero, G. P; Demirci, U. B.; Miele, P. Int. J. Hydrogen Energy 2011, 36, 7051-7065; and Sun, D.; Mazumder, V.; Metin, O.; Sun, S. ACS Catal. 2012, 2, 1290-1295; and considering also the role a nickel catalyst plays to selectively hydrogenate nitro or nitrile groups to R—NH₂, see Shimizu, K.; Kon, K.; Onodera, W.; Yamazaki, H.; Kondo, J. N. ACS Catal. 2013, 3, 112-117; and Gowda, S.; Gowda, D. C. Tetrahedron, 2002, 58, 2211-2213, it was further decided to explore bimetallic MPd NPs, especially NiPd NPs, as potentially efficient tandem reaction catalysts.

### SUMMARY

Bimetallic nanoparticles are synthesized for catalyzing the tandem reaction of dehydrogenating ammonia borane (AB) and hydrogenating nitrogen compounds to primary amines. Polycrystalline nanoparticles are formed and assembled or distributed on a support to form a supported catalyst for the tandem reactions, and the feed stocks or precursors are fed in solution with the supported catalyst. The catalyst may be recovered and be repeatedly reused in a clean environmentally-friendly process for synthesis of amines. In proof-of-principle examples, the nickel-palladium nanoparticles were formed in solution by co-reduction of nickel and palladium salts, and assembled on a graphene support G; when tested on a range of alkyl- and aryl nitro compounds, the NPs were found to provide highly efficient catalysis for hydrogenating the nitrogen-containing groups. Certain aspects of the invention herein have been reported in a published article entitled Tandem Dehydrogenation of Ammonia Borane and Hydrogenation of Nitro/Nitrile Compounds Catalyzed by Graphene-Supported NiPd Alloy Nanoparticles, ACS Catal., 2014, 4 (6), pp 1777-1782. The Supporting Information for that article, which is freely available from the publisher ACS Catalysis, contains further information, drawings, Tables and analytic measurements and data related to variations in particle manufacture, and reports measured catalyst activity and operation on a range of nitro- or nitrile compounds. Both that Article and its Supporting Information are hereby incorporated by reference herein in their entirety. In addition, certain portions of the discussion and text below reference specific drawings, graphs, tables or data of the Supporting Information when discussing NiPd nanoparticles, embodiments of the invention, methods of use, and the scope of synthesis processes using such nanoparticles on various supports. References to data in the Supporting Information will in general include a prefix S- as part of the relevant drawing or Table number.

### BRIEF DESCRIPTION OF THE DRAWINGS

These and other features of the invention will be understood from the description and illustrative drawings below, wherein

FIG. 1A is a TEM image of the as-synthesized of Ni₃₀Pd₇₀NPs;

FIG. 1B is a HRTEM image of single NiPd NP showing its polycrystalline nature;

FIG. 1C shows X ray diffraction patterns of Pd and NiPd nanoparticles;

FIG. 1D shows a TEM image of the as-prepared G-NiPd catalyst comprised of the nanoparticles assembled on a graphene support.

FIG. 2 is a cartoon illustrating tandem catalysis of AB dehydrogenation and of hydrogenation of nitro- or nitrile-groups to primary amines;

FIG. 3 (TABLE 1) shows pairs of alkyl- or aromatic nitro hydrogenation targets and corresponding amine products, showing yields and reaction speeds; and

FIG. 4 (TABLE 2) shows a further seven nitrile hydrogenation targets and the hydrogenation reaction speeds and yields.

### DETAILED DESCRIPTION OF INVENTION

The invention herein includes a synthesis of NiPd NPs and their assembly on a support, preferably graphene (G), as supported nanoparticles effective for catalyzing the tandem reactions of AB dehydrogenation and R—NO₂ and/or R—CN hydrogenation to R—NH₂ in an environmentally-friendly process, e.g., in aqueous methanol solution at room temperature. By way of background, recently applicant and others reported the synthesis of metal-Pd nanoparticles (MPd NPs, M: Co, or Cu) by reduction of PdBr₂ and M(acac)₂ (acac=acetylacetonate) at 260° C. in oleylamine (OAm) and trioctylphosphine (TOP). See Mazumder, V.; Chi, M.; Mankin, M.; Liu, Y.; Metin, Ö.; Sun, D.; More, K. L.; Sun, S. Nano Lett. 2012, 12, 1102-1106. The TOP-coated CoPd NPs were active catalyst for the hydrolysis of AB. Sun, D.; Mazumder, V.; Metin, Ö. Sun, S. ACS Nano 2011, 5, 6458-6464. However, the NPs were inactive for hydrogenation reaction, and the activation process to remove TOP led to degradation of NP quality. The invention herein involves a new route to synthesis of MPd NPs that does not involve trioctylphosphine, and that provides improved MPd catalysis activity.

In this synthesis, NiPd NPs are now prepared by co-reduction of Ni and Pd-salt precursors by borane-tert-butylamine (BBA) in OAm. The NiPd NPs so produced are active not only for AB dehydrogenation, but also for the hydrogenation of R—NO₂ and/or R—CN to RNH₂. Further, when the NiPd NPs were deposited on G, they became a highly efficient catalyst for tandem AB dehydrogenation and hydrogenation reactions in aqueous solution at room temperature. When tested for tandem reaction on a variety of R—NO₂ and/or R—CN feed compounds, it was found that NO₂ and CN bonds were reduced selectively to produce R—NH₂ in very short (5-30 minute) reaction times, and with high conversion yields reaching up to 100%.

### Preparation of Supported Nanoparticle Catalyst Materials

The NP synthesis was carried out using standard airless procedures and commercially available reagents. All reagents were used as received. Oleylamine (OAm) (>70%), borane-tert-butylamine (BBA, 97%), palladium acetylacetonate (Pd(acac)₂, 99%), activated carbon (DARCO®-100 mesh particle size), aluminum oxide nanopowder (<50 nm (BET)) and all nitro and/or nitrile compounds used in the tandem reaction were purchased from Sigma-Aldrich and used as received. Nickel (II) acetate tetrahydrate (98%) was obtained from Strem chemicals.

### Characterization Methods

Samples for transmission electron microscopy (TEM) analysis were prepared by depositing a single drop of the diluted NP dispersion in hexane amorphous carbon coated copper grids. Images were obtained on a Philips CM20 at 200 kV. High resolution TEM (HRTEM) images were obtained on a JEOL 2100F with an accelerating voltage of 200 kV. X-ray diffraction (XRD) patterns were collected on a Bruker AXS D8-Advanced diffractometer with Cu Kα radiation (λ=1.5418 Å). Inductively coupled plasma (ICP) elemental analysis measurements were carried out on a JY2000 Ultrace ICP Atomic Emission Spectrometer equipped with a JY AS 421 autosampler and 2400 g/mm holographic grating. For ICP analysis, an aliquot of the NPs in hexane was dried and subsequently dissolved in warm (˜75° C.) aqua regia for 30 min to ensure complete dissolution of metal into the acid. The solution was then diluted with 2% HNO₃ solution for analysis. ¹H-NMR and ¹³C-NMR spectra were recorded on a Bruker Avance DPX 400 MHz spectrometer.

### Synthesis of NiPd Alloy NPs

In a typical synthesis of Ni₃₀Pd₇₀ NPs, 0.2 mmol of palladium (II) acetylacetonate (Pd(acac)₂) and 0.2 mmol of nickel (II) acetate tetrahydrate (Ni(ac)₂.4H₂O) were dissolved in 3 mL of OAm. The precursor mixture was quickly injected into a mixture of 200 mg of BBA, 3 mL of OAm and 7 mL of 1-octadecene (ODE) at 100° C. under magnetic stirring in an argon environment. The reaction was allowed to proceed for 1 h and cooled to room temperature. Then acetone/ethanol (v/v=7/3) was added and the NP product was separated by centrifugation at 9000 rpm for 10 min. The NPs were redispersed in hexane and then stored for further use.

### Assembly of NiPd Alloy NPs on G

In a typical procedure, 10 mg of the NiPd NPs were dissolved in 5.0 mL hexane and mixed with 30.0 mg of G in ethanol (60 mL) The ethanol/hexane mixture was sonicated for 2 h to ensure complete adsorption of NPs onto G. Then, the resultant mixture was centrifuged at 8000 rpm for 10 min and the separated catalyst was washed with ethanol twice and dried under vacuum, giving G-NiPd. The NiPd NPs were also supported on activated carbon (C—NiPd) and aluminum oxide powder (Al₂O₃—NiPd) by using same method and catalyst loading described above.

### General Procedure for the Catalytic Tandem Reactions

The R—NO₂ or R—CN (1 mmol), G-NiPd catalyst (4 mg), and water:methanol (3:7) were stirred 5 min in a 100 mL thermolysis tube at room temperature. Next, AB (3 mmol) was added to the reaction mixture and the vessel was closed. Reaction was then continued under vigorous stirring at room temperature. The progress of the catalytic reaction was monitored by thin layered chromatography (TLC). Most reactions completed over the time period of 5-30 min. After completion of the reaction, the catalysts were removed by centrifugation at 7000 rpm and washed three times with water or methanol. Then, the catalysts were allowed to dry for further uses. The solvent was removed by using a rotary evaporator. Finally, the crude residue was directly purified by column chromatography on silica gel using acetone. The yields of the reduced compounds were determined by ¹H and ¹³C NMR with D₂O, DMSO, CD₃OD or CDCl₃ as the solvent depending on the product separated.

### Experimental Results and Discussion

NiPd alloy NPs were synthesized via the co-reduction of nickel(II) acetate, Ni(ac)₂, and palladium(II) acetlyacetonate, Pd(acac)₂, by BBA in OAm and 1-octadecene (ODE). In the synthesis, OAm acted as a surfactant, BBA served as a reducing agent and ODE was used as a solvent. The metal contents of the NiPd alloy NPs were analyzed by inductively coupled plasma-atomic emission spectroscopy (ICP-AES), and characteristics of different particles measured. In the current reaction condition, Ni30Pd₇₀ NPs were obtained by reducing 0.2 mmol of Ni(ac)₂.H₂O and 0.2 mmol of Pd(acac)₂. Ni₂₀Pd₈₀ NPs were synthesized by changing the Ni:Pd molar ratio to 0.1:0.25.

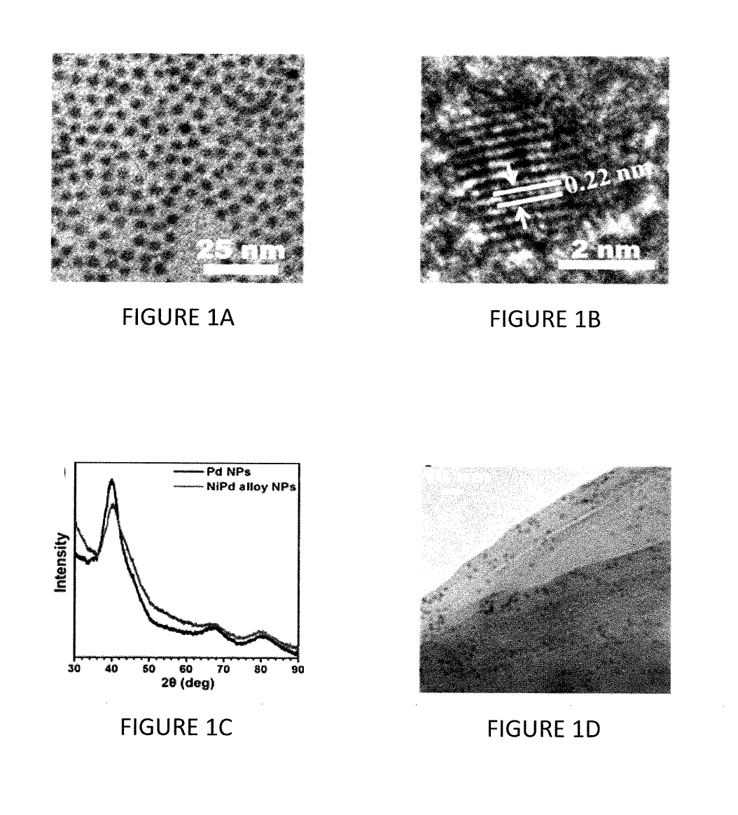

FIG. 1A shows a representative TEM image of the as-synthesized of Ni₃₀Pd₇₀ NPs. The NPs are monodisperse with a mean particle size of 3.4+0.3 nm in diameter. FIG. 1B is a representative HRTEM image of single NiPd NP in which the polycrystalline nature of the NP is seen. The lattice fringe distance is at 0.22 nm, which is closer to the lattice spacing of the (111) planes of the face centered cubic (fcc) Pd (0.223 nm) and larger than that of the fcc-Ni (0.203 nm), indicating that Pd-rich NiPd structure is indeed formed. FIG. 1C shows the x-ray diffraction (XRD) patterns of Pd and NiPd NPs. By using the Scherrer equation, the crystal size of the NiPd NPs was calculated to be 2.8 nm. This size is smaller than that measured from TEM, indicating that the as-synthesized NPs are in polycrystalline structure. Furthermore, the (111) peak shifts to higher diffraction angle (2θ=40.3°) compared to the corresponding peak from the Pd NPs (2θ=39.5°), indicating the (111) lattice spacing of the NiPd NPs is smaller than that of the Pd NPs. This is consistent with what is seen from the HRTEM analysis of the NiPd NP (FIG. 1B), confirming that NiPd NPs have a solid solution structure.

The NiPd NP size and composition can be controlled by the temperature at which the metal precursors are injected into the reaction. For example, the injection of 0.30 mmol of Ni(ac)₂ and 0.25 mmol of Pd(acac)₂ into the BBA solution at 75° C. yielded 3.3+0.3 nm Ni₃₅Pd₇₅ NPs (shown in Figure S-3A of the published Supporting Information, see Appendix A filed herewith) whereas the injection at 125° C. gave 3.9±0.4 nm Ni₅₀Pd₅₀ NPs (shown in Figure S-3B of the Supporting Information). It is noteworthy to mention that alloying Ni with Pd is thermodynamically difficult and the synthesis of alloy NPs with the higher Ni:Pd ratio could not be achieved at temperatures higher than 125° C. The relatively large lattice mismatch between Ni and Pd (9.4-10%)—see: Chang, C. J. Magn. Magn. Mater 1991, 96, L1-L7; and Porte, L.; Phaner-Goutorbe, M.; Guigner, J. M.; Bertolini, J. C. Surf Sci. 1999, 424, 262-270—might make it difficult for the two metals to intermix well together, presenting a different situation from the formation of CoPd and CuPd, which have smaller lattice mismatches: Co/Pd (4.5%)—see Singh, A. K., Xu, Q. ChemCatChem, 2013, 5, 652-676—and Cu/Pd (7.1%)—see Jin, M.; Zhang, H.; Zhong, X.; Lu, N.; Li, Z.; Xia, Z.; Kim, M. J.; Xia, Y. ACS Nano, 2012, 6, 2566-2573. Previous studies also indicate Ni and Pd have difficulty forming a solid solution and NiPd alloy NPs are often produced by the Ni/Pd interdiffusion of the preformed Pd/Ni core/shell NPs at temperatures greater than 265° C. see, Zhang, M.; Yan, Z.; Sun, Q.; Xie, J.; Jing, J. New J. Chem. 2012, 36, 2533-2540; Son, S. U.; Jong, Y.; Park, J.; Na, H. B.; Park, H. M.; Yun, H. J.; Lee, J.; Hyeon, T. J. Am. Chem, Soc. 2004, 126, 5026-5027; Metin, Ö.; Ho, S. F.; Alp, C.; Can, H.; Mankin, M. N.; Gültekin, M. S.; Chi, M.; Sun, S. Nano Res. 2013, 6, 10-18; see also Lee, K.; Kang, S. W.; Lee, S.; Park, K-H.; Lee Y. W.; Han, S. W. ACS Appl. Mater. Interfaces 2012, 4, 4208-4214.

To perform catalytic tests, we deposited the NiPd NPs on graphene (G) through the sonication of an ethanol dispersion of G and a hexane dispersion of NiPd NPs, using a method similar to that reported for assembly of FePt NPs on G in Guo, S.; Sun, S. J. Am. Chem. Soc. 2012, 134, 2492-2495. This resulted in the graphene-supported G-NiPd NPs. FIG. 1D shows a TEM image of the G-NiPd catalyst so prepared. The NiPd NPs are well-dispersed on the G surface and their initial morphology and size remain preserved during the assembly process. Without any further surfactant removal treatment, this G-NiPd catalyst was tested directly for the tandem reaction.

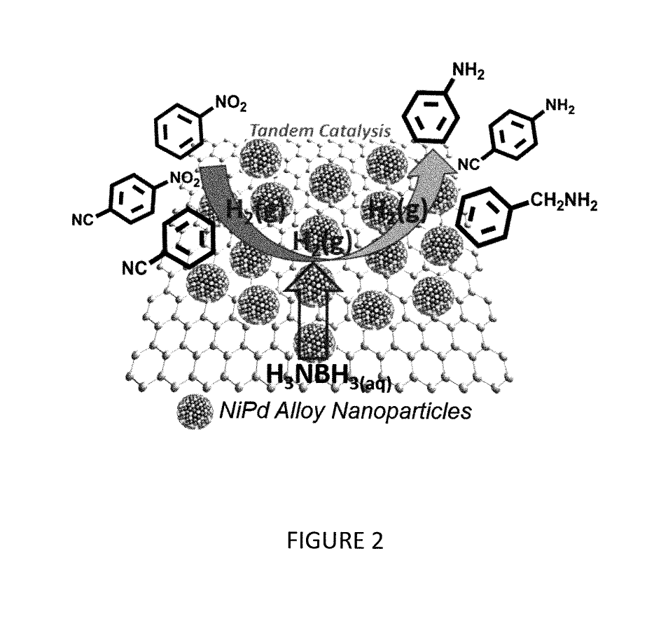

FIG. 2 is a schematic illustration of the tandem reactions using nanoparticles supported on graphene to act upon the H₃NBH₃ aqueous feedstock (AB) in solution with the hydrogenation target. The FIGURE shows hydrogenation of nitrobenzene to aniline, and several other hydrogenation target catalyses.

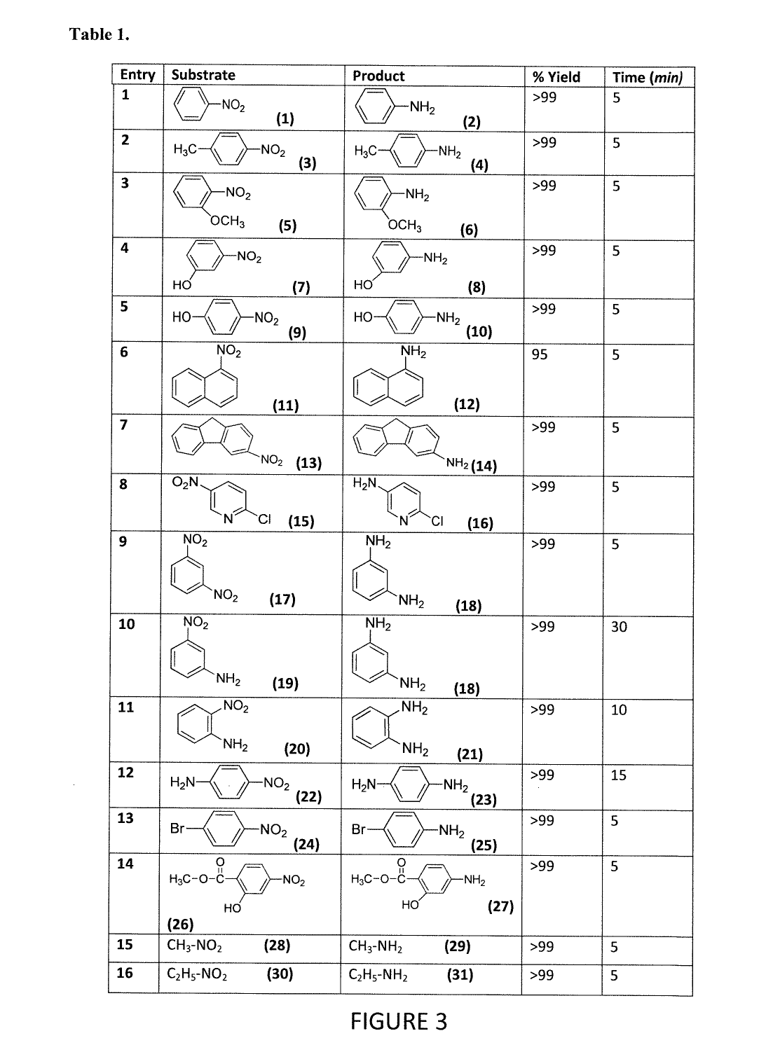

We first used nitrobenzene (or its simple derivative) as a model compound to demonstrate G-NiPd NP catalysis for the tandem dehydrogenation of AB and hydrogenation of R—NO₂ and to determine optimum NP composition and reaction conditions. We tested the catalytic tandem reactions at room temperature in different solvents including water, methanol, ethanol and their mixtures at various ratios, and determined that the mixed solvent of methanol/water (v/v=7/3) was the best solvent combination to convert nitrobenzene (1) to aniline (2)—see line 1 of TABLE 1 in FIG. 3.

Among three different G-NiPd nanoparticle batches tested for the tandem reduction, the G-Ni₃₀Pd₇₀ showed the highest efficiency with high amine conversion yields in short reaction times. Therefore, the G-Ni₃₀Pd₇₀ catalyst was selected to catalyze tandem AB dehydrogenation and hydrogenation reactions for different nitro- and nitrile compounds; the different target molecules and reaction results are shown in FIG. 3, TABLE 1.

We further studied precursor effects, e.g., the influence of different AB/nitrobenzene ratios, on the catalytic tandem reactions (Table S1 of the Supporting Information shows data for different feed proportions on Ni₃₀Pd₇₀ catalyzed reactions). The conversion yields increased with increasing the AB/nitrobenzene ratios, reaching the maximum 100% when the ratio was at 3. We also studied the influence of the support on Ni₃₀Pd₇₀ catalysis. These NPs supported on either conventional carbon support (C—Ni₃₀Pd₇₀) (Figure S1, Supporting Information) or aluminum oxide nanopowder (Al₂O₃—Ni₃₀Pd₇₀) (Figure S2) were active catalysts for the tandem reaction to reduce p-nitrophenol to 4-aminophenol, but the conversion yields were lower than for NPs on graphene support (54% and 55%, respectively). G has an atomically flat surface and high adsorption power for organic molecules; when G was used as a support, both the NiPd NPs and reactants would be more strongly adsorbed on G than on C or Al₂O₃, and the G—Ni₃₀Pd₇₀ NPs were found to exhibit much increased catalytic efficiency due to the high local reactant concentration.

Finally, it was found that the NP catalyst was a necessary component for the tandem reaction, as no product was obtained over 24 h when the reaction was performed in the absence of the catalyst. From these tests, we can conclude that 3 equivalent of AB in methanol/water mixture (v/v=7/3) at room temperature is the optimum reaction condition for the G-Ni₃₀Pd₇₀ NPs to catalyze the tandem reaction.

FIG. 3, Table 1 summarizes the results obtained from G-Ni₃₀Pd₇₀ catalyzed tandem reactions of various R-NO₂ (nitro-) compounds. All aromatic or aliphatic nitro compounds tested were converted into the respective primary amines with excellent conversion yields in 5-30 min at room temperature. See Table S2 of the Supporting Information for the activities of various other catalyst systems tested in the reduction of aromatic nitro compounds including transfer hydrogenation route.

Using the G-Ni₃₀Pd₇₀ catalyst, for example, nitrobenzene (1) was reduced to aniline (2) quantitatively in 5 min (Table-1, entry 1). The NO₂ groups in p-methyl, o-methoxy and p-hydroxyl-nitrobenzenes (3, 5, 7, 9) were also reduced into the related amine products (4, 6, 8, 10) in nearly quantitative conversion yields in 5 min (Table-1, entries 2-5). The catalytic reaction could be easily extended to 2-nitro-naphthyl (11), 3-nitro-9H-fluorene (13) and 2-chloro-5-nitropyridine (15) compounds, which were all converted to respective amine derivatives (12, 14, 16) with the conversion yields higher than 95% in 5 min (Table-1, entries 6-8). These amine derivatives with hetero-aromatic structures are especially important medicinal agents due to their potent antimicrobial and insecticidal properties. See—Patrick, G. L.; Kinsman, O. S. Eur. J. Med. Chem. 1996, 31, 615-624; (b) Nagashree, S.; Mallesha, L.; Mallu, P. Pharma Chem., 2013, 5, 50-55.

For 1,3-dinitrobenzene (17), both NO₂ groups were reduced quantitatively to NH₂ (18) in 5 min (Table 1, entry 9). Reduction of meta-amino-nitrobenzene (19) was a little slower process, reaching 100% conversion after 30 min of reaction (Table 1, entry 10). Other amino-nitrobenzenes (20, 22) were reduced similarly to 1,3-dinitrobenzene, producing the corresponding diamine products (Table 1, entries 11, 12). The selective reduction —NO₂ was better demonstrated in aromatic compounds bearing other reducible substituents such as 1-bromo-4-nitrobenzene (24) and methyl 2-hydroxy-4-nitrobenzoate (26). They were all reduced to the related amine products (>99% conversion in 5 min) (Table 1, entries 13,14) and the Br— or ester group showed no obvious effect on the NO₂ reduction kinetics. The tandem reaction could be further extended to the simple aliphatic nitro compounds such as methyl nitro (28) and ethyl nitro (30) compounds that were all converted quantitatively to the related primary amines (29, 31) in 5 min (Table 1, entries 15, 16). The tabulated synthetic results demonstrate that the G-NiPd NP catalyzed tandem reaction is highly efficient and selective for —NO₂ reduction into —NH₂ and that other functional groups around NO₂ have little effect on the reduction outcome. This is also consistent with the literature observations that —NO₂ is easily reduced. See—Ciardelli, F.; Pertici, P.; Vitulli, G.; Giaiacopi, S.; Ruggeri, G.; Pucci, A. Macromol. Symp. 2006, 231, 125-133; also Pehlivan, L.; Metay, E.; Laval, S.; Dayoub, W.; Demonchaux, P.; Mignani, G.; Lemaire, M. Tetrahedron 2011, 67, 1971-1976; and Takasaki, M.; Motoyama, Y.; Higashi, K.; Yoon, S-H.; Mochida, I.; Nagashima, H. Org. Lett. 2008, 10, 1601-1604.

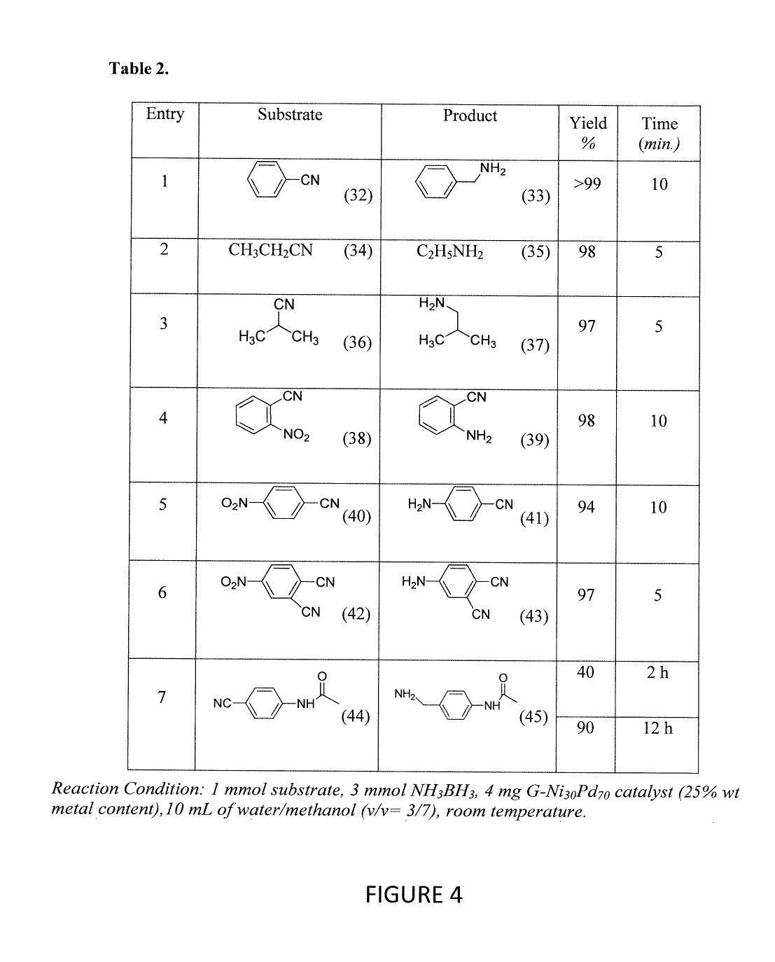

The G-NiPd NPs were found to be equally active in catalyzing the tandem reaction to reduce aromatic and aliphatic nitrile compounds to the corresponding amines in conversion yields up to 100% within 10 min (entries 1-3 of Table 2, shown in FIG. 4). However, when the starting compounds bearing both —CN and —NO₂ moieties, such as cyano-nitrobenzene, only NO₂ but not CN, was reduced to NH₂ (Table 2, entries 4-6). To explore this selectivity, additional tests were performed on p-aminobenzonitrile (41) and its acetated derivative, p-cyanophenylacetamide (target molecule 44 in TABLE 2, line 7). These showed that when (41) was used as a substrate, only 3% conversion was achieved in 2 hours, and longer reaction times (up to 12 h) did not lead to any notable increase on the yield of the corresponding amine derivative p-aminomethylaniline. When p-cyanophenylacetamide (44) was present in the tandem reaction condition, the —CN was more easily reduced to —NH₂ with the conversion yield up to 90% after 12 h of reaction. By way of comparison, the tandem reaction of AB with the mixture of nitrobenzene (1) and benzonitrile (32) (1:1 molar ratio) yielded the respective amines (2, 33) quantitatively. From these experimental results, it was concluded that while the G-NiPd-catalyzed tandem reaction is very active and selective to reduce —NO₂ to —NH₂, the same reaction condition has very limited power to reduce —CN when this —CN is conjugated with —NO₂ and/or —NH₂ in an arene structure. This limited reduction is believed to be caused by the electronic/conjugation effect of —NH₂ on —CN, which stabilizes the —CN against further reduction.

The G-NiPd NPs and their catalysis on the tandem reaction can be compared favorably with other methods reported for the reduction of R—NO₂, as shown in Table S2 of the Supporting Information. In general, the G-NiPd-catalyzed reactions proceed much faster at room temperature. Other methods require longer time and/or higher reaction temperatures. For example, Au NPs supported on magnesium oxide (MgO—Au) have been reported to catalyze NaB H₄ reduction of nitrobenzene, producing aniline in 85% yield after 1 h reaction at room temperature—see, Layek, K.; Kantam, M. L.; Shirai, M.; Hamane, D. N.; Sasaki, T.; Maheswaran, H. Green Chem. 2012, 14, 3164-3174; and in the presence of Au/TiO₂, AB reduced nitrobenzene to aniline in 92% yield after 30 min at 25° C. (See—Vasilikogiannaki, E.; Gryparis, C.; Kotzabasaki, V.; Lykakis, I. N.; Stratakis, M. Adv. Synth. Catal. 2013, 355, 907-911. As a comparison, the G-NiPd NP catalyzed reaction converted nitrobenzene to aniline in >99% yield after only 5 min reaction at room temperature.

An extra benefit of using the new G-NiPd catalyst for tandem AB dehydrogenation and R—NO₂/R—CN hydrogenation is that it is stable and reusable. Its durability was tested by performing the tandem reaction on p-nitrophenol. The catalyst was separated after each reaction and washed with water/methanol for the next round of reaction. After the 5^{th} consecutive use, the catalyst still exhibited a conversion yield higher than 95% in the same reaction times. We believe that the high activity and stability of the G-NiPd catalyst stems from its stable dispersion in water/methanol and from the presence of a graphitic plane near the G-NiPd, which enriches all reactants around each NiPd NP, facilitating the tandem reaction. The G-NiPd thus constitutes a clean, long-lived and re-usable catalyst for ‘green chemistry’ processes.

The foregoing description and reported data and reaction characteristics thus document an improved method and materials for catalytic production of primary amines. We have reported a facile route to monodisperse 3.4 nm NiPd alloy NPs. These NiPd NPs are deposited on graphene (G) support using solution-phase self-assembly, and the supported G-NiPd catalyst was demonstrated to be efficient in catalyzing the tandem reaction of dehydrogenation of AB and hydrogenation of R—NO₂ or R—CN to produce primary amines R—NH₂. Fast, high yield catalytic reactions were run in the aqueous methanol solutions at room temperature. In the series of aromatic or aliphatic nitro and/or nitrile compounds tested, all were reduced to the respective primary amines with excellent conversion yields in short reaction times of 5 to 30 minutes. Compared to the known hydrogenation methods, approach reported herein has the following distinct advantages: 1) the catalyst is efficient, reusable and cost-effective; 2) the tandem reaction can be performed in an environment-friendly and safe process (no stored/pressurized hydrogen is needed); 3) the reaction is easy to operate at ambient conditions with short reaction times and high yields; 4) the reduction is especially selective for R-NO₂; 5) the reduction is also active for R—CN when there is no π-conjugated —NO₂ and —NH₂ co-present with —CN. The invention thus opens up a new path to selective reduction of R—NO₂ and/or R—CN to R—NH₂.

The invention being thus disclosed and aspects of its tuning and operation explored, further variations and modification thereof, as well as adaptations to desired chemical syntheses, will occur to those skilled in the art, and are considered to be within the scope of the invention as set forth above and in the following claims.

1. Catalytic material for catalyzing a desired chemical change, conversion or synthesis, wherein the catalytic material comprises nickel palladium (NiPd) alloy nanoparticles supported on a carbon support, and wherein the plural metals are selected, the nanoparticles are sized and the support is selected such that the catalytic material is effective to catalyze a tandem reaction that dehydrogenates a first hydrogen-rich feedstock or group and hydrogenates a second nitrogen-containing feedstock or group to primary amine.

2. The catalytic material of claim 1, wherein the carbon support is graphene and the second feedstock is or includes an organic nitro- or nitrile- group that is catalyzed to an amine.

3. The catalytic material of claim 1, wherein the nanoparticles are grown as polycrystalline solid solution or alloy nanoparticles having a particle size between about 2 and 4 nm.

4. The catalytic material of claim 1, wherein the nanoparticles are alloy nanoparticles having a particle size 2 to 4 nm deposited or grown on graphene to tune their activity for catalytic action on a side group of an organic feed.

5. The catalytic material of claim 1, tuned for tandem reactions dehydrogenating an ammonia borane feedstock and hydrogenating a nitrogen-containing group to an amine.

6. The catalytic material of claim 1, wherein the nanoparticles are alloy nanoparticles used to produce a pharmaceutical compound, a pharmaceutical intermediate or an aniline material.

7. The catalytic material of claim 1, wherein nanoparticles are alloy nanoparticles having a particle size 2 to 4 nm deposited or grown on graphene to form a supported catalyst for hydrogenation of an organic feedstock comprising an arene, a heteroarene or an alkyl arene with a nitro side group, wherein the tandem reactions are performed in solution and the supported catalyst is recoverable and reusable.

8. The catalytic material of claim 7, wherein the nanoparticles have a palladium-rich polycrystalline structure, for example Ni₃₀Pd₇₀, Ni₂₀Pd₈₀ or the like, wherein nickel content is no more than 50%.

9. The catalytic material of claim 8, wherein particle activity is tuned by one or more steps selected from the group of controlling molar ratio of nickel and palladium salts in a solution phase co-reduction particle-producing reaction; controlling temperature of solution phase co-reduction of nickel and palladium; or both.

10. A process for making a nanoparticle catalyst useful in solution phase synthesis of organic amines, the process comprising the steps of forming polycrystalline nickel/palladium alloy nanoparticles, and assembling the nanoparticles on a carbon support.

11. A catalyst made by the process of claim 10, wherein the carbon support is graphene and the graphene-supported nanoparticles catalyze tandem dehydrogenation and hydrogenation reactions in liquid phase using ammonia borane to produce primary amines.
